(19) United States
(12) Patent Application Publication
(10) Pub. No.: US 2025/0294456 A1
(43) Pub. Date: Sep. 18, 2025

(54) LP-SS BASED TA VALIDATION FOR CG-SDT

(71) Applicant: QUALCOMM Incorporated, San Diego, CA (US)

(72) Inventors: Prashant SHARMA, San Marcos, CA (US); Changhwan PARK, San Diego, CA (US); Hyunwoo CHO, San Diego, CA (US); Jae Ho RYU, San Diego, CA (US)

(21) Appl. No.: 18/605,705

(22) Filed: Mar. 14, 2024

(51) Int. Cl. H04W 52/02; H04W 56/00; H04W 76/20

(52) U.S. Cl. CPC H04W 52/0235; H04W 56/0015; H04W 56/0045; H04W 76/20

(57) ABSTRACT

Apparatus, methods, and computer program products for wireless communication are provided. An example method may include receiving a low-power synchronization signal (LP SS) via a wake-up radio (WUR). The example method may further include performing a first measurement to validate a timing advance (TA) associated with a configured grant small data transmission (CG-SDT) occasion based on the LP SS via the WUR. The example method may further include at least one of waking up, based on a successful validation of the TA, a main radio (MR) during the CG-SDT occasion to transmit a CG-SDT transmission or waking up, based on an unsuccessful validation of the TA, the MR to start a random access small data transmission (RA-SDT) procedure.

### TECHNICAL FIELD

The present disclosure relates generally to communication systems, and more particularly, to wireless communication systems with small data transmission (SDT).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to receive a low-power synchronization signal (LP SS) via a wake-up radio (WUR). Based at least in part on information stored in the at least one memory, the at least one processor, individually or in any combination, is configured to perform a first measurement to validate a timing advance (TA) associated with a configured grant small data transmission (CG-SDT) occasion based on the LP SS via the WUR. Based at least in part on information stored in the at least one memory, the at least one processor, individually or in any combination, is configured to wake up, based on a successful validation of the TA, a main radio (MR) during the CG-SDT occasion to transmit a CG-SDT transmission or wake up, based on an unsuccessful validation of the TA, the MR to start a random access small data transmission (RA-SDT) procedure.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example low-power wake-up radio (LP WUR) and main radio (MR), in accordance with various aspects of the present disclosure.

FIG. 5 is a diagram illustrating example operations of LP WUR and MR, in accordance with various aspects of the present disclosure.

FIG. 6 is a diagram illustrating example timings associated with operations of LP WUR and MR, in accordance with various aspects of the present disclosure.

FIG. 7 is a diagram illustrating example communications between a network entity and a UE.

FIG. 8 is a diagram illustrating example timings associated with configured grant small data transmission (CG SDT) or random access small data transmission (RA SDT) procedures of a UE without LP WUR and a UE with LP WUR, in accordance with various aspects of the present disclosure.

FIG. 9 is a flowchart of a method of wireless communication.

FIG. 10 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Small data transmission (SDT) is a procedure that allows data and/or signaling transmission while the device remains in inactive state without transitioning to connected state. SDT may be performed via random access (RA), which may be referred to as RA SDT, or performed based on configured grant (CG), which may be referred to as CG SDT. In order to perform CG SDT, the UE may perform timing advance (TA) validation which may involve comparing a first measurement at the time of receiving a configuration for a CG occasion and a second measurement which may be performed later to check if the first measurement and the second measurement differ by an amount more than a configured threshold. If the first measurement and the second measurement differ by an amount less than the configured threshold, the TA may be valid and the UE may perform CG SDT in a configured CG occasion. In some wireless communication systems, a UE may wake up main radio (MR) to perform these measurements and the SDT transmission. However, waking up the MR to perform the TA validation may result in a situation where the TA is invalid and the UE woke up the MR without performing a subsequent SDT transmission, resulting in additional higher power consumption. Aspects provided herein may enable a UE to perform TA validation for a SDT transmission based on low-power wake-up radio (LP WUR) to save power.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

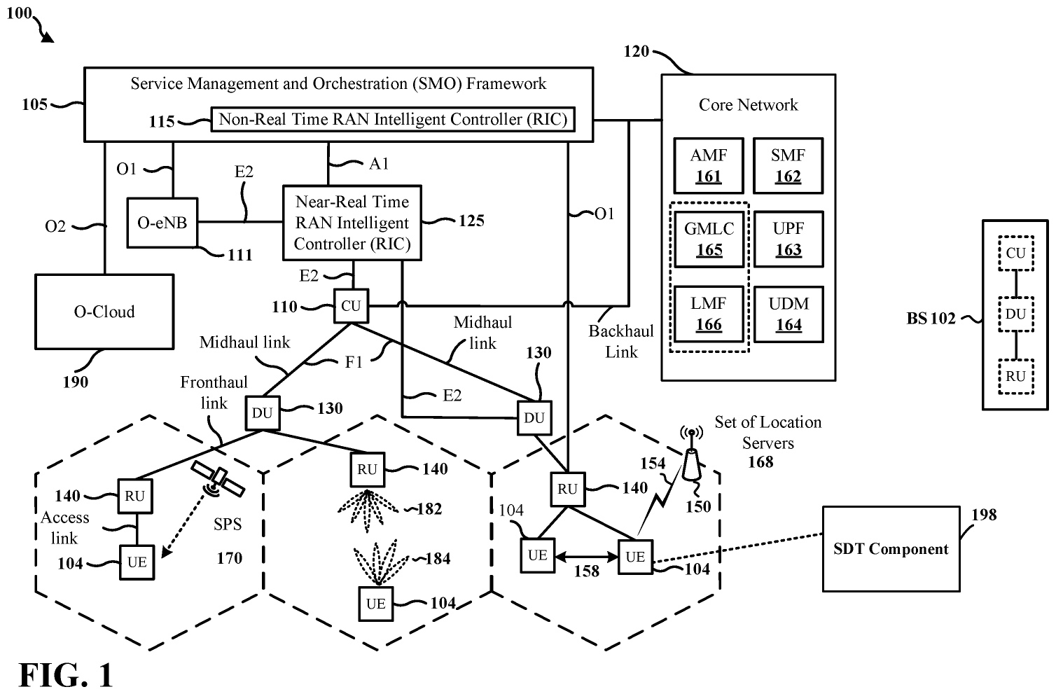

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a SDT component 198. In some aspects, the SDT component 198 may be configured to receive a low-power synchronization signal (LP SS) via a wake-up radio (WUR). In some aspects, the SDT component 198 may be further configured to perform a first measurement to validate a timing advance (TA) associated with a configured grant small data transmission (CG-SDT) occasion based on the LP SS via the WUR. In some aspects, the SDT component 198 may be further configured to wake up, based on a successful validation of the TA, a main radio (MR) during the CG-SDT occasion to transmit a CG-SDT transmission or wake up, based on an unsuccessful validation of the TA, the MR to start a random access small data transmission (RA-SDT) procedure.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

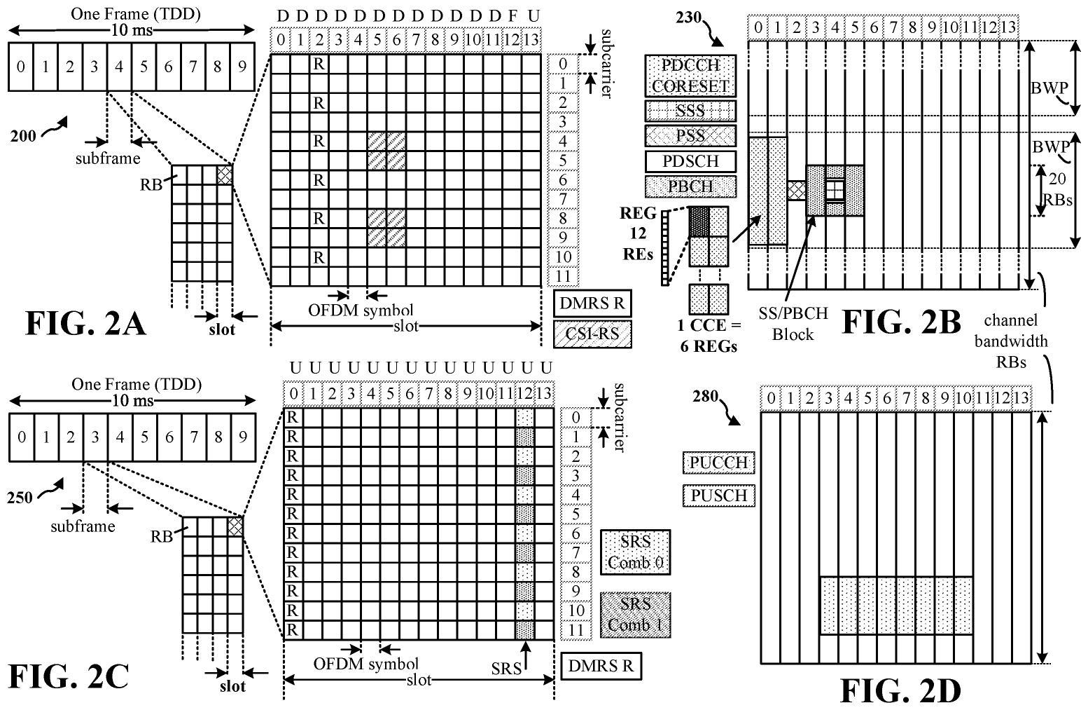

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

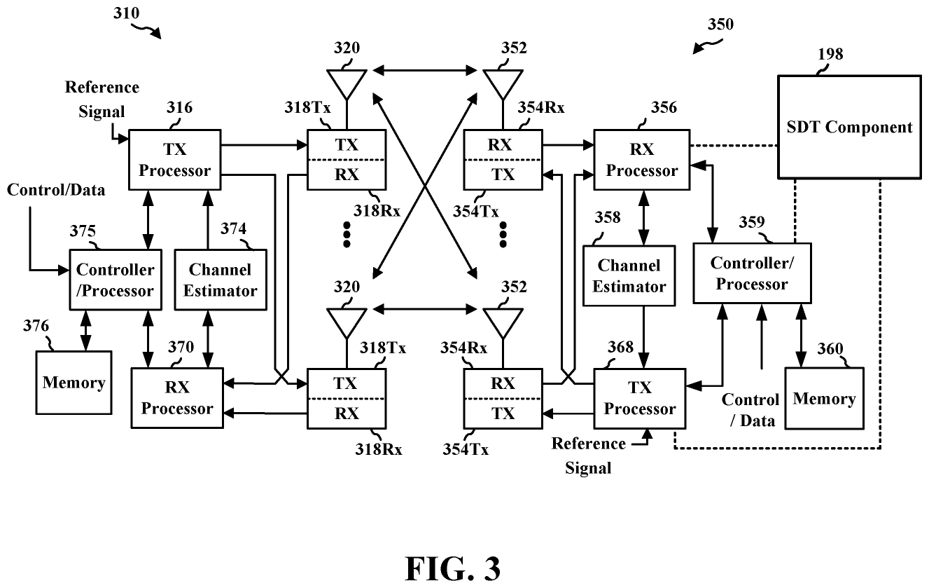

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with SDT component 198 of FIG. 1.

As used herein, the term “measurement” may refer to a measurement generated by measuring a reference signal, such as a low power synchronization signal (LP SS) or the like. A measurement may be based on a particular metric, such as a reference signal received power (RSRP), a received signal strength indicator (RSSI), a signal to interference and noise ratio (SINR), or a reference signal received quality (RSRQ). As used herein, the term “validation” may refer to the process of verifying a TA is still applicable or not based on whether measurement(s) associated with the UE has changed by a degree above a threshold. If the measurement has changed by an amount more than the threshold, the TA may not be validated. If the measurement has changed by an amount less than the threshold, the TA may be validated. As used herein, the term “MR” may refer to a radio at a UE that may consume more power than a WUR and may be able to enter a sleep state (which may be also referred to as a “deep sleep state”) to save power. A WUR may be a low power radio that consumes less power than the MR and may have less functionality than the MR.

As used herein, the term “CG-SDT occasion” may refer to a particular scheduled time occasion for a UE to transmit a CG-SDT transmission.

Usage of LP WUR may reduce total power consumption because an unnecessary awake time of the more power consuming MR may be avoided. Usage of LP WUR may also reduce total latency. Because the LP WUR consumes low power, it may allow frequent WUS monitoring, reducing average latency (e.g., less average latency compared to waking up MR less frequently). Example performance metrics for LP WUR may include WUR power consumption (which may be lower than sleep power of MR to enable extended operation). Example performance metrics for LP WUR may include sensitivity where higher sensitivity enables better coverage. Power hungry blocks may be avoided for low power operation, resulting in poor sensitivity and potential coverage mismatch between of WUR and MR. Therefore, sensitivity at the LP WUR may be a performance metric. Example performance metrics for LP WUR may also include data rate, false alarm or false wake up probability (false wake up may result in more power consumption), miss detection probability (miss detection may lead to poor reliability and increased delay), and MR wake-up time (which is correlated to overall latency).

Example waveforms used for LP WUR signals, such as LP WUS or LP RS, may include OFDM-based waveforms where the receiver may process the WUS at baseband and may reuse MR component to receive the LP WUS or on-off keying (OOK) based waveform where the receiver uses an envelope detector, which may enable a LP WUR that is completely separate from the MR and a larger power saving. OOK may be a modulation scheme of keying a sinusoidal carrier signal on and off with a unipolar binary signal (two level amplitude keying where a first amplitude represents on and a second amplitude represents off).

LP WUS may be used for paging reception and may be associated with a paging early indication. To enable a LP WUR at a wireless device to perform radio resource management, time or frequency (T/F) tracking, and resynchronization, aspects provided herein may provide LP RS. The wireless device may use such a LP RS in a variety of different configurations. For example, if the LP WUR supports OOK waveform and the LP WUR bandwidth is less than or equal to 5 MHz with a noise figure around 7 decibels, LP RS may be based on OOK for T/F synchronization and the LP RS may be based on OOK waveform. As another example, if the LP WUR supports OOK waveform and the LP WUR bandwidth is approximately 1 MHz with a noise figure approximately 5 decibels, LP RS may be used if minimum coupling loss (MCL) is 164 decibels or less. MCL may be the minimum distance loss including antenna gain measured between antenna connectors. In another example, if the LP WUR supports OOK waveform and the LP WUR bandwidth is approximately 5 MHz with a noise figure approximately 5 decibels, the wireless device might be able to not use LP RS to satisfy a MCL of 140 decibels. As used herein, the term “LP RS” may refer to a signal received via a LP WUR that is used for T/F tracking and radio resource management. LP RS may be carried on LP RS resources (which may be arranged as LP RS resource sets). The term “LP WUS” may refer to a signal received via a LP WUR that is used for waking up the MR and may be associated with a paging early indication, an idle discontinuous reception (DRX) cycle (e.g., associated with paging monitoring occasions), wakeup monitoring occasions associated with a connected-mode DRX cycle, or the like. In some aspects, the term “monitoring occasion” may refer to a configured time occasion where a UE is configured to monitor a transmission. In some aspects, a low power wakeup receiver may be referred to as a low power wakeup radio and a main receiver may be referred to as a main radio, and vice versa. As described herein, reference to a radio may include reference to a radio, a receiver, or a transceiver; and vice versa. For example, a low power receiver may also be referred to as a low power radio, a low power transceiver, or the like. As another example, a main receiver may also be referred to as a main radio, a main transceiver, or the like. As another example, a main radio may also be referred to as a main receiver, a main transceiver, or the like. The term “power state” may refer to a power state of a main radio. For example, the main radio may wake up from a sleep state, an off state, or another state where the main radio is configured to refrain from receiving or transmitting some (or all) communications to save power to an on state or an awake state.

In some aspects, LP WUS may be a coded control signal that may be based on polar coding other types of coding. In some aspects, LP WUS may be a sequence based signal (e.g., based on discrete Fourier transform, Gold, amplitude shift keying (ASK), phase shift keying (PSK), pulse position modulation (PPM), pulse width modulation (PWM), pulse amplitude modulation (PAM), Walsh, m-seq, Zadoff, Reed Solomon, or the like). In some aspects, the LP WUS may be a time-domain sequence based signal which may be based on modulating the time domain signal/waveform with a sequence. In some aspects, LP WUS may be an on-off keying (OOK) based waveform signal where the waveform may be OFDM and based on modulating the time domain signal/waveform with low and high voltage signals. In some aspects, the LP RS may be a sequence based signal (e.g., based on DFT, Gold, ASK, PSK, PPM, PWM, PAM, Walsh, m-seq, Zadoff, Reed Solomon, or the like). In some aspects, the LP RS may be a time-domain sequence based signal which may be based on modulating the time domain signal with a sequence of complex numbers/parameters/coefficients. In some aspects, LP RS may be an on-off keying (OOK) based waveform signal where the waveform may be OFDM and based on modulating the time domain signal/waveform with low and high voltage signals.

In some aspects, there may be a subtype of LP RS used for synchronization. The subtype of LP RS may be a sequence based signal. In some aspects, the subtype of LP RS may be a time-domain sequence based signal which may be based on modulating the time domain signal with a sequence of complex numbers/parameters/coefficients. In some aspects, the subtype of LP RS may be an on-off keying (OOK) based waveform signal where the waveform may be OFDM, DFT-s-OFDM, or single carrier QAM (SC-QAM) and based on modulating the time domain signal/waveform with low and high voltage signals.

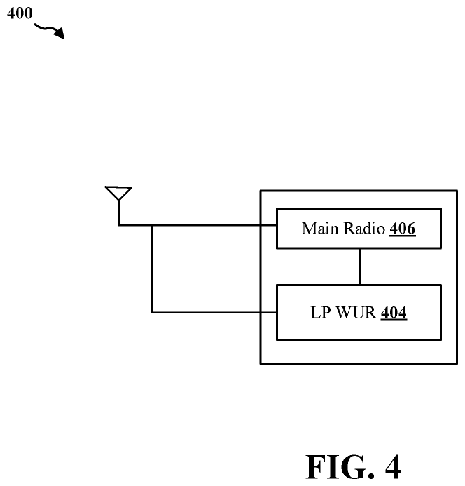

FIG. 4 is a diagram 400 illustrating example LP WUR 404 and MR 406. A LP WUR receiver may be a receiver separate from the MR 406 on a wireless device. The LP WUR 404 may be used for enabling lower power consumption at the wireless device and may have a lower power consumption than the MR. To save power, the MR may enter a sleep mode and the LP WUR may be periodically listening (which may also be referred to as “monitoring”) for a WUS.

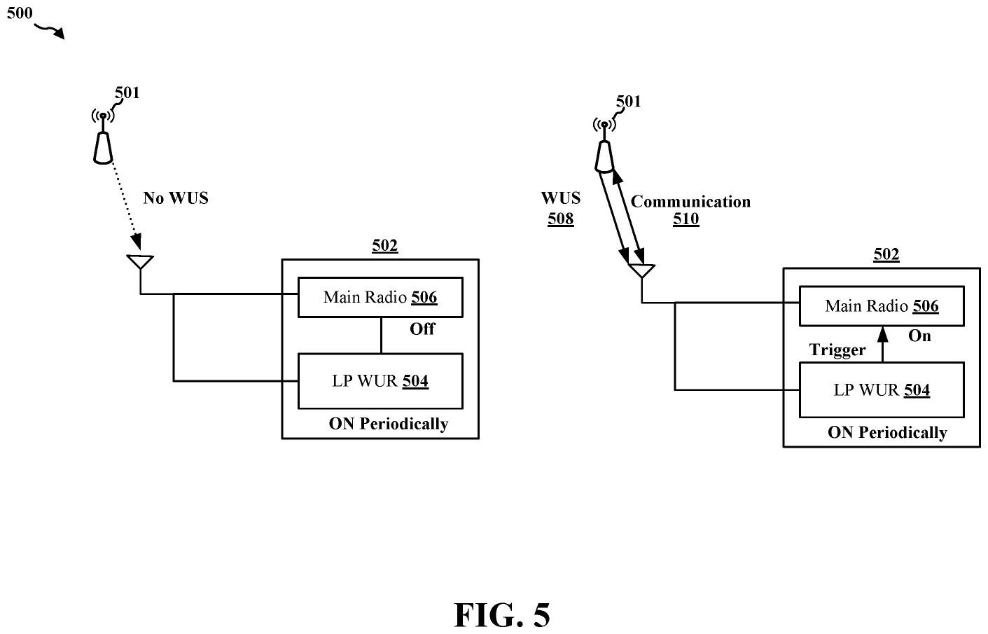

FIG. 5 is a diagram 500 illustrating example operations of LP WUR 504 and MR 506 on a wireless device 502. When there is no WUS transmitted from the network entity 501, the LP WUR 504 may be periodically listening to the WUS and the MR 506 may be in a sleep mode (e.g., off). Upon receiving WUS 508 via the LP WUR 504, the wireless device 502 may turn on the MR to enable data communications 510 via the MR based on a trigger from the LP WUR 504.

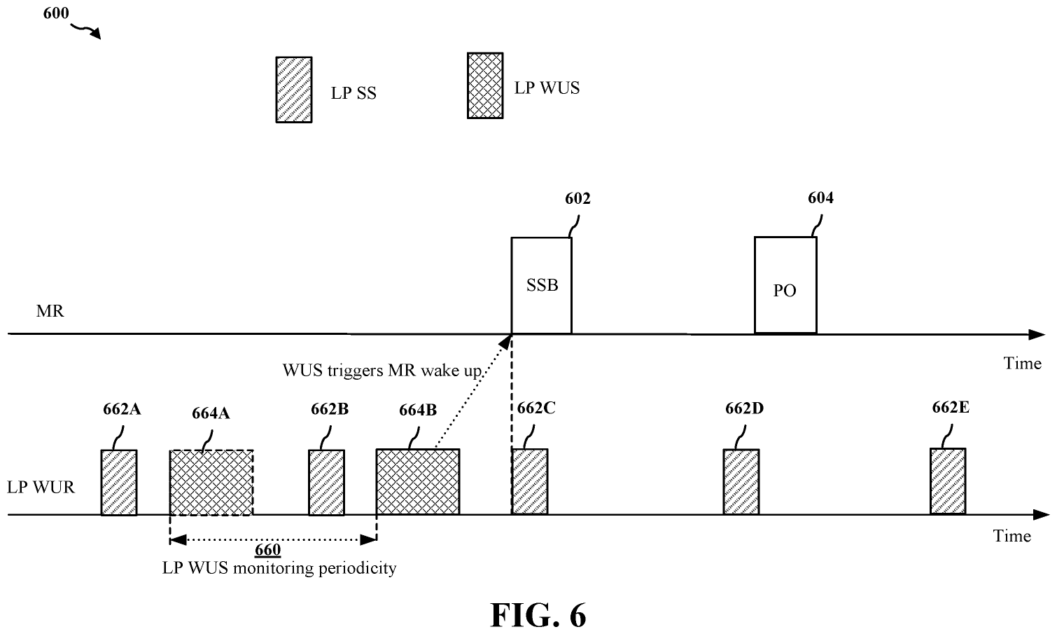

FIG. 6 is a diagram 600 illustrating example timings associated with operations of LP WUR and MR, in accordance with various aspects of the present disclosure. As illustrated in FIG. 6, LP SS may be transmitted periodically including LP SS 662A, LP SS 662B, LP SS 662C, LP SS 662D, and LP SS 662E to assist LP WUR with time/frequency synchronization. A UE may be configured to monitor for LP WUS periodically based on a LP WUS monitoring periodicity 660. In a first time occasion 664A, the UE may not detect a LP WUS. In a second time occasion 664B, the UE may be able to detect a LP WUS. As an example, based on detecting the LP WUS, the UE may wake up MR to receive an SSB 602 and receive a paging occasion 604. In an IDLE/INACTIVE mode, a lot of the power consumption may come from radio resource management (RRM) measurements for cell reselection. A LP WUR may not be able to reduce power consumption by a large amount if the MR wakes up frequently to perform cell-selection related measurements. A larger amount of reduction in power consumption may be achieved if some of the cell-reselection procedures can be handled by the LP WUR.

Small data transmission (SDT) is a procedure that allows data and/or signaling transmission while the device remains in inactive state without transitioning to connected state. SDT may be performed via random access (RA), which may be referred to as RA SDT, or performed based on configured grant (CG), which may be referred to as CG SDT. In order to perform CG SDT, the UE may perform timing advance (TA) validation which may involve comparing a first measurement at the time of receiving a configuration for a CG occasion and a second measurement which may be performed later to check if the first measurement and the second measurement differ by an amount more than a configured threshold. If the first measurement and the second measurement differ by an amount less than the configured threshold, the TA may be valid and the UE may perform CG SDT in a configured CG occasion. In some wireless communication systems, a UE may wake up MR to perform these measurements and the SDT transmission. However, waking up the MR to perform the TA validation may result in a situation where the TA is invalid and the UE woke up the MR without performing a subsequent SDT transmission, resulting in additional higher power consumption. Aspects provided herein may enable a UE to perform TA validation for a SDT transmission based on LP WUR to save power.

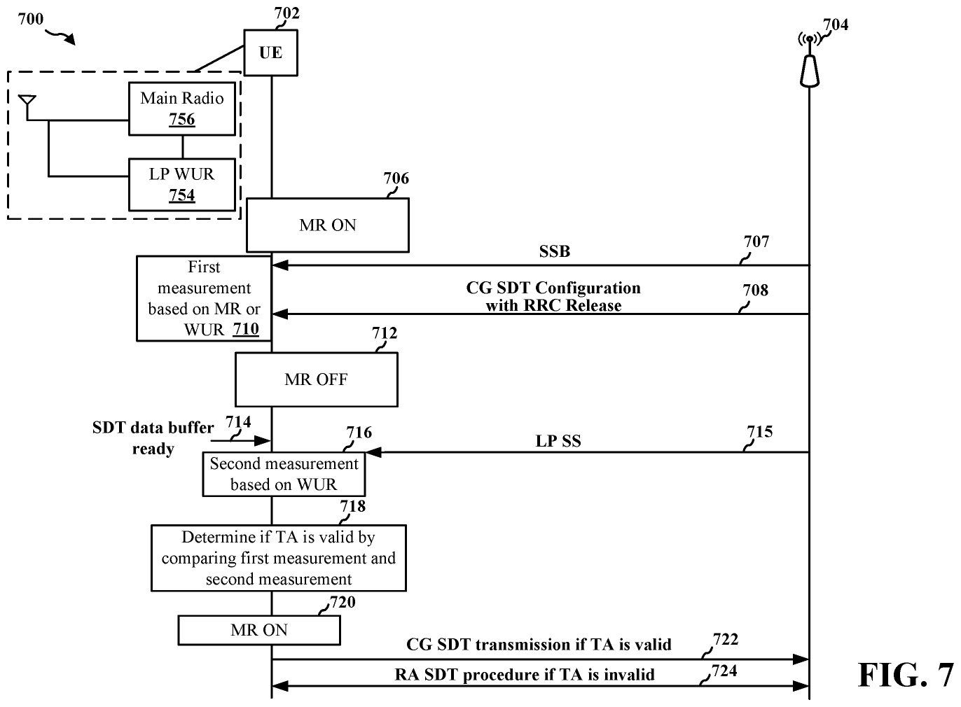

FIG. 7 is a diagram 700 illustrating example communications between a network entity 704 and a UE 702. In some aspects, the network entity 704 may be referred to as a network node. In some aspects, the network node may be implemented as an aggregated base station, a component of a disaggregated base station, an integrated access and backhaul (IAB) node, a relay node, a sidelink node, or the like. In some aspects, the network entity 704 may be implemented in an aggregated or monolithic base station architecture, or alternatively, in a disaggregated base station architecture, and may include one or more of a CU, a DU, an RU, a Near-Real Time (Near-RT) RAN Intelligent Controller (RIC), or a Non-Real Time (Non-RT) RIC. In some aspects, the UE 702 may include a MR 756 and a LP WUR 754. In some aspects, the LP WUR 754 may be used to receive and transmit LP RS or LP WUS. In some aspects, the LP WUR 754 may be ultra-low power with passive components for both receiving and transmitting, enabling longer sleep time for MR 756. The LP WUR 754 may wake up MR 756 under different circumstances based on aspects described herein. In some aspects, the LP WUR 754 may include a transceiver with envelope detection-based reception or a transceiver that may process OFDM waveforms. In some aspects, the transceiver may use load modulation based transmission, e.g., absorbing or reflecting incoming EM waves (which may be otherwise referred to as “carrier wave”). In some aspects, the transceiver included as part of the LP WUR 754 may be associated with integrated circuit (IC) support for processing UL and DL data (e.g., reading memory, computing cyclic redundancy check (CRC)). In some aspects, the LP WUR 754 may be equipped with power harvesting circuitry enabling wireless power harvesting and charging the battery in idle mode.

As illustrated in FIG. 7, the UE 702 may have the MR 756 be awake (on) at 706 and may receive CG SDT configuration 708 with an RRC release command on the MR 756. The CG SDT configuration 708 may be configure a TA and one or more CG SDT occasions associated with the TA. In some aspects, the TA may be configured separately from the CG SDT configuration and defined to be associated with the CG SDT configuration 710. At 710, the UE 702 may perform a first measurement based on one of RSRP, RSSI, SINR, or the like during a time window that includes the reception of the TA or the CG-SDT configuration. The measurement at 710 may be based on the MR 756 or the LP WUR 754. In aspects where the measurement at 710 may be based on the MR 756, the MR 756 may perform the measurement based on a timing T1 associated with an RRC release with the CG-SDT configuration 708 or a latest TA received if the TA is received while in RRC inactive state and based on a timing T1′ associated with completing the measurement. The LP WUR 754 may determine (e.g., map) a corresponding first measurement on the LP WUR based on a specified offset. In some aspects, the LP WUR 754 may generate the first measurement based on a specified time window around the timing T1. After performing the measurement at 710, the UE 702 may enter a sleep state at the MR at 712.

In some aspects, SDT data buffer may be ready at 714 which means that there may be SDT data to be transmitted in a buffer of the UE 702. At 716, the LP WUR 754 may perform a second measurement based on LP SS 715 using a same metric (e.g., one of RSRP, RSSI, SINR, or the like) as the first measurement at 710 within a specified time window before a timing T2 associated with TA validation. In some aspects, the second measurement at 716 may be performed outside the specified time window. In some aspects, the UE 702 may not be able to perform the second measurement at 716 within a larger specified window. In such aspects, the MR 756 may directly wake up to perform the second measurement for TA validation.

There may be a one-to-one relationship (e.g., based on quasi-co-location (QCL)) between an LP-SS and an SSB. Regarding the QCL types, QCL type A may include the Doppler shift, the Doppler spread, the average delay, and the delay spread; QCL type B may include the Doppler shift and the Doppler spread; QCL type C may include the Doppler shift and the average delay; and QCL type D may include the spatial Rx parameters (e.g., associated with beam information such as beamforming properties for finding a beam). In some aspects, the LP SS 715 used for the second measurement at 716 may have a QCL relation with an SSB 707 used for the first measurement at 710.

The second measurement may be assumed to be explicitly/implicitly related to a corresponding measurement based on the offset. In some aspects, the specified time window for the second measurement may be the same length as the specified time window for the first measurement. In some aspects, the specified time window for the second measurement may have a different length from the specified time window for the first measurement. In some aspects, the specified time window for the second measurement may be separately configured from the specified time window for the first measurement.

In some aspects, the UE 702, such as the LP WUR 754, may determine if the TA configured in connection with the CG SDT configuration 708 is valid or invalid at 718 by verifying if the second measurement (or the corresponding measurement of the second measurement based on the specified offset) has increased or decreased from the first measurement (or the corresponding measurement of the first measurement based on the specified offset) by more than a threshold. In some aspects, the threshold may be configured by the network entity 704. In some aspects, the threshold may be configured independent of signaling the network entity 704. In some aspects, the threshold may correspond to a cg-SDT-RSRP-ChangeThreshold information element associated with CG SDT or a separate cg-SDT-LP SS-RSRP-ChangeThreshold information element associated with LP SS of CG SDT.

In some aspects, at 718, the UE 702 may determine that the TA is valid based on the second measurement based on the specified offset having not increased or decreased from the first measurement (or the corresponding measurement of the first measurement based on the specified offset) by more than the threshold. In such aspects, the WUR may validate the TA for a subsequent CG SDT occasion (which may be configured by the CG SDT configuration 708) and the MR 756 may wake up at 720 to transmit a CG SDT transmission 722 in the subsequent CG SDT occasion. In some aspects, if the second measurement at 716 is performed within the specified time window, the MR 756 may transmit the CG SDT transmission 722 and may re-perform TA validation. In some aspects, if the second measurement at 716 is performed within the specified time window, the MR 756 may transmit the CG SDT transmission 722 without re-performing TA validation.

In some aspects, at 718, the UE 702 may determine that the TA is invalid based on the second measurement based on the specified offset having increased or decreased from the first measurement (or the corresponding measurement of the first measurement based on the specified offset) by more than the threshold. In such aspects, the WUR may not validate the TA for a subsequent CG SDT occasion (which may be configured by the CG SDT configuration 708) and the MR 756 may wake up at 720 to start an RA SDT procedure 724 with the network entity 704.

In some aspects, to start the procedure illustrated in FIG. 7, the UE 702 may indicate UE capability associated with performing measurement(s) on the LP WUR for the purpose of TA validation for CG SDT to the network entity 704. In some aspects, the UE 702 may output an indication of the wake up of the MR during the CG-SDT occasion or the wake up of the MR to start the RA-SDT procedure, such as by transmitting the indication of the wake up of the MR during the CG-SDT occasion or storing the indication of the wake up of the MR during the CG-SDT occasion or the wake up of the MR to start the RA-SDT procedure.

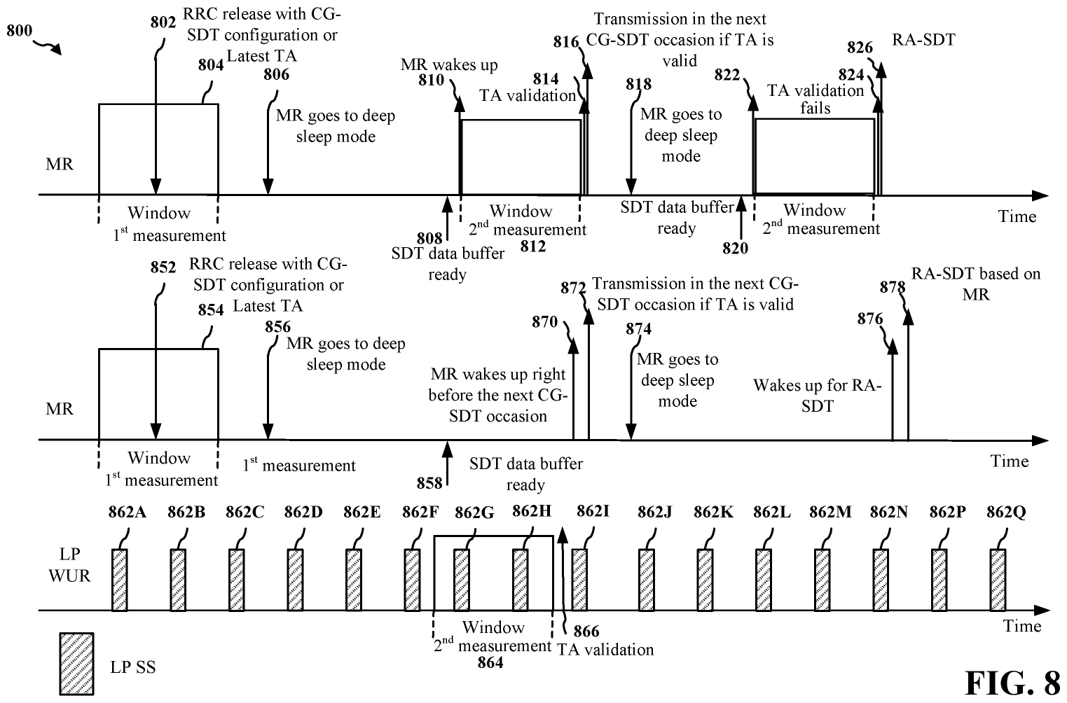

FIG. 8 is a diagram 800 illustrating example timings associated CG SDT procedures of a UE without LP WUR and a UE with LP WUR, in accordance with various aspects of the present disclosure. As illustrated in FIG. 8, for a UE without a LP WUR, at 802, the UE may receive an RRC release with a CG SDT configuration or latest TA and may perform a first measurement within a window 804. At 806, the UE may enter a sleep mode on the MR. At 808, there may be SDT data buffer ready at the UE and the UE may accordingly wake up the MR at 810 and perform a second measurement within a window 812 for TA validation. At 814, if the TA is valid based on the first measurement and the second measurement not differing by more than a threshold, the UE may transmit a CG SDT transmission at 816 and the MR may enter sleep mode again at 818. At 820, there may be SDT data buffer ready at the UE and the UE may accordingly wake up the MR at 822 and perform a second measurement within a window for TA validation. At 824, if the TA is invalid based on the first measurement and the second measurement differ by more than a threshold, the UE may start an RA SDT procedure at 826.

As illustrated in FIG. 8, for a UE with a LP WUR, at 852, the UE may receive an RRC release with a CG SDT configuration or latest TA and may perform a first measurement within a window 854. At 856, the UE may enter a sleep mode on the MR. At 858, there may be SDT data buffer ready at the UE. The LP WUR may perform a second measurement within a window 864 for TA validation. LP SS, including LP SS 862A, LP SS 862B, LP SS 862C, LP SS 862D, LP SS 862E, LP SS 862F, LP SS 862G, LP SS 862H, LP SS 862I, LP SS 862J, LP SS 862K, LP SS 862L, LP SS 862M, LP SS 862N, LP SS 862P, and LP SS 862Q may be provided to facilitate operations of LP WUR at the UE. At 866, the TA may be validated based on the first measurement and the second measurement not differing by more than a threshold. The UE may accordingly wake up the MR at 870 right before the next CG SDT occasion, the UE may transmit a CG SDT transmission at 872, and the MR may enter sleep mode again at 874. If the TA is not validated, at 876, the UE may accordingly wake up the MR to start an RA SDT procedure 878.

Therefore, as illustrated in FIG. 8, based on aspects provided herein, a UE with LP WUR may be able to wake up MR less frequently and power saving may be achieved.

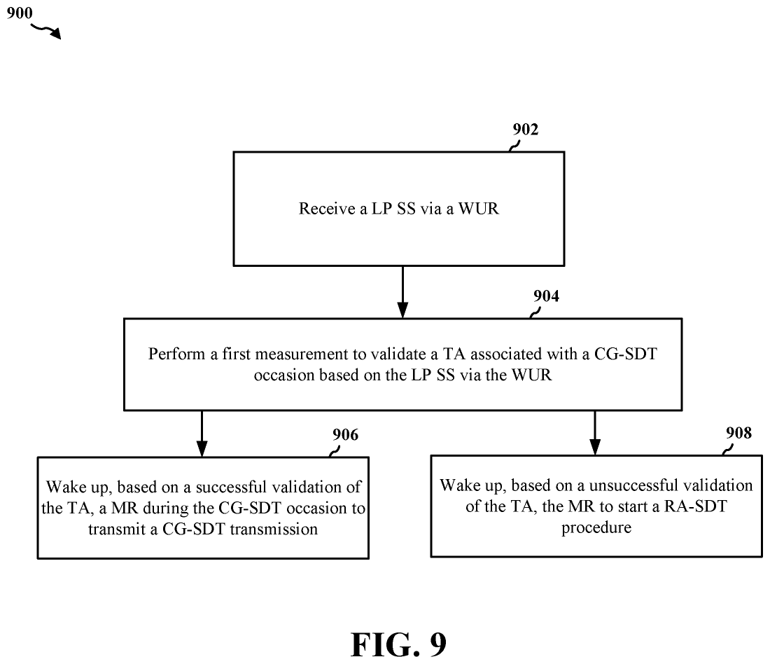

FIG. 9 is a flowchart 900 of a method of wireless communication. The method may be performed by a UE (e.g., the UE 104, the UE 702; the apparatus 1004).

At 902, the UE may receive a LP SS via a WUR. For example, the UE 702 may receive a LP SS (e.g., 715) via a WUR (e.g., 754). In some aspects, 902 may be performed by SDT component 198.

At 904, the UE may perform a first measurement to validate a TA associated with a CG-SDT occasion based on the LP SS via the WUR. For example, the UE 702 may perform a first measurement (e.g., at 716) to validate a TA associated with a CG-SDT occasion based on the LP SS via the WUR. In some aspects, 904 may be performed by SDT component 198.

At 906, the UE may wake up, based on a successful validation of the TA, a MR during the CG-SDT occasion to transmit a CG-SDT transmission or at 908, the UE may wake up, based on an unsuccessful validation of the TA, the MR to start an RA-SDT procedure. For example, the UE 702 may wake up (e.g., 720), based on a successful validation of the TA, a MR (e.g., 756) during the CG-SDT occasion to transmit a CG-SDT transmission (e.g., 722) or wake up (e.g., 720), based on an unsuccessful validation of the TA, the MR to start an RA-SDT procedure (e.g., 724). In some aspects, 906 may be performed by SDT component 198.

In some aspects, the UE may receive the TA while in an RRC inactive state or an RRC release command with CG SDT configuration (e.g., 708) via the MR. In some aspects, the UE may enter a sleep mode (e.g., at 712) on the MR after reception of the TA or the CG-SDT configuration.

In some aspects, the UE may perform a second measurement (e.g., at 710) during a time window that includes the reception of the TA or the CG-SDT configuration via the MR or the WUR. In some aspects, the UE may compare the first measurement with the second measurement. In some aspects, the UE may determine (e.g., at 718), based on a difference between the first measurement and the second measurement being above a threshold, that the validation of the TA is unsuccessful. In some aspects, the UE may determine, based on the difference between the first measurement and the second measurement being below the threshold, that the validation of the TA is successful.

In some aspects, the UE may perform the second measurement via the MR and may map the second measurement to the WUR. In some aspects, the UE may perform the second measurement via the WUR. In some aspects, the first measurement and the second measurement are based on one of an RSRP, an RSSI, an SINR, or an RSRQ. In some aspects, the UE may refrain from performing, based on the unsuccessful validation of the TA by the WUR and based on the first measurement being within the time window, a second validation of the TA via the MR.

In some aspects, the UE may perform, based on the unsuccessful validation of the TA by the WUR and based on the first measurement being outside of the time window, a second validation of the TA via the MR. In some aspects, the UE may perform the first measurement while the MR is in the sleep mode. In some aspects, the CG-SDT configuration is included in the RRC release command.

In some aspects, the UE may output an indication of the wake up of the MR during the CG-SDT occasion or the wake up of the MR to start the RA-SDT procedure. In some aspects, the UE may transmit the indication of the wake up of the MR during the CG-SDT occasion or the wake up of the MR to start the RA-SDT procedure or store the indication of the wake up of the MR during the CG-SDT occasion or the wake up of the MR to start the RA-SDT procedure.

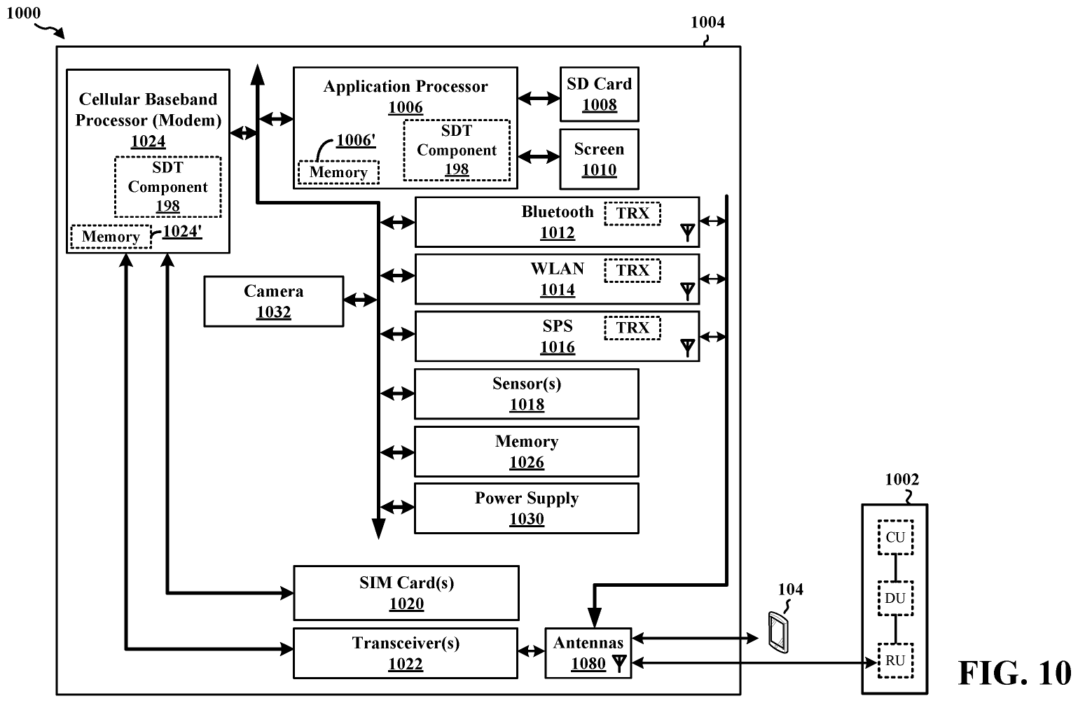

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) 1024 communicates through the transceiver(s) 1022 via one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the SDT component 198 may be configured to receive a low-power synchronization signal (LP SS) via a wake-up radio (WUR); and perform a first measurement to validate a timing advance (TA) associated with a configured grant small data transmission (CG-SDT) occasion based on the LP SS via the WUR; and at least one of: wake up, based on a successful validation of the TA, a main radio (MR) during the CG-SDT occasion to transmit a CG-SDT transmission; or wake up, based on an unsuccessful validation of the TA, the MR to start a random access small data transmission (RA-SDT) procedure. The SDT component 198 may be within the cellular baseband processor(s) 1024, the application processor(s) 1006, or both the cellular baseband processor(s) 1024 and the application processor(s) 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for receiving a LP SS via a WUR. In some aspects, the apparatus 1004 may include means for performing a first measurement to validate a TA associated with a CG-SDT occasion based on the LP SS via the WUR. In some aspects, the apparatus 1004 may include means for waking up, based on a successful validation of the TA, a MR during the CG-SDT occasion to transmit a CG-SDT transmission. In some aspects, the apparatus 1004 may include means for waking up, based on an unsuccessful validation of the TA, the MR to start an RA-SDT procedure. In some aspects, the apparatus 1004 may include means for receiving the TA while in an RRC inactive state or an RRC release command with CG-SDT configuration via the MR. In some aspects, the apparatus 1004 may include means for entering a sleep mode on the MR after a reception of the TA or the CG-SDT configuration. In some aspects, the apparatus 1004 may include means for performing a second measurement during a time window that includes the reception of the TA or the CG-SDT configuration via the MR or the WUR. In some aspects, the apparatus 1004 may include means for comparing the first measurement with the second measurement. In some aspects, the apparatus 1004 may include means for determining, based on a difference between the first measurement and the second measurement being above a threshold, that the validation of the TA is unsuccessful. In some aspects, the apparatus 1004 may include means for determining, based on the difference between the first measurement and the second measurement being below the threshold, that the validation of the TA is successful. In some aspects, the apparatus 1004 may include means for mapping the second measurement to the WUR. In some aspects, the apparatus 1004 may include means for refraining from performing, based on the unsuccessful validation of the TA by the WUR and based on the first measurement being within the time window, a second validation of the TA via the MR. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method performed by a user equipment (UE), including: receiving a LP SS via a WUR; and performing a first measurement to validate a TA associated with a CG-SDT occasion based on the LP SS via the WUR; and at least one of: waking up, based on a successful validation of the TA, a MR during the CG-SDT occasion to transmit a CG-SDT transmission; or waking up, based on an unsuccessful validation of the TA, the MR to start an RA-SDT procedure.

Aspect 2 is the method of aspect 1, further including: receiving the TA while in an RRC inactive state or an RRC release command with CG-SDT configuration via the MR; and entering a sleep mode on the MR after a reception of the TA or the CG-SDT configuration.

Aspect 3 is the method of aspect 2, further including: performing a second measurement during a time window that includes the reception of the TA or the CG-SDT configuration via the MR or the WUR.

Aspect 4 is the method of aspect 3, further including: comparing the first measurement with the second measurement; and at least one of: determining, based on a difference between the first measurement and the second measurement being above a threshold, that the validation of the TA is unsuccessful, or determining, based on the difference between the first measurement and the second measurement being below the threshold, that the validation of the TA is successful.

Aspect 5 is the method of any of aspects 3-4, where performing the second measurement includes performing the second measurement via the MR, and further including: mapping the second measurement to the WUR.

Aspect 6 is the method of any of aspects 3-4, where performing the second measurement includes performing the second measurement via the WUR.

Aspect 7 is the method of any of aspects 3-6, where the first measurement and the second measurement are based on one of an RSRP, an RSSI, an SINR, or an RSRQ.

Aspect 8 is the method of any of aspects 3-7, further including: refraining from performing, based on the unsuccessful validation of the TA by the WUR and based on the first measurement being within the time window, a second validation of the TA via the MR.

Aspect 9 is the method of any of aspects 3-8, further including: performing, based on the unsuccessful validation of the TA by the WUR and based on the first measurement being outside of the time window, a second validation of the TA via the MR.

Aspect 10 is the method of any of aspects 2-9, where performing the first measurement includes performing the first measurement while the MR is in the sleep mode.

Aspect 11 is the method of any of aspects 2-10, where the CG-SDT configuration is included in the RRC release command.

Aspect 12 is the method of any of aspects 1-11, further including: outputting an indication of the wake up of the MR during the CG-SDT occasion or the wake up of the MR to start the RA-SDT procedure.

Aspect 13 is the method of any of aspects 1-12, where outputting the indication further includes: transmitting the indication of the wake up of the MR during the CG-SDT occasion or the wake up of the MR to start the RA-SDT procedure; or storing the indication of the wake up of the MR during the CG-SDT occasion or the wake up of the MR to start the RA-SDT procedure.

Aspect 14 is an apparatus for wireless communication at a wireless device including at least one memory and at least one processor coupled to the at least one memory and, based at least in part on information stored in the at least one memory, the at least one processor is configured, individually or in combination, to implement any of aspects 1 to 13.

Aspect 15 is the apparatus of aspect 14, further including one or more transceivers or one or more antennas coupled to the at least one processor.

Aspect 16 is an apparatus for wireless communication at a wireless device including means for implementing any of aspects 1 to 13.

Aspect 17 is a computer-readable medium (e.g., a non-transitory computer-readable medium) storing computer executable code, where the code when executed by at least one processor causes the at least one processor to implement any of aspects 1 to 13.

What is claimed is:

1. An apparatus for wireless communication at a user equipment (UE), comprising:
at least one memory; and
at least one processor coupled to the at least one memory, and based at least in part on information stored in the at least one memory, the at least one processor, individually or in any combination, is configured to cause the UE to:
receive a low-power synchronization signal (LP SS) via a wake-up radio (WUR); and
perform a first measurement to validate a timing advance (TA) associated with a configured grant small data transmission (CG-SDT) occasion based on the LP SS via the WUR; and at least one of:
wake up, based on a successful validation of the TA, a main radio (MR) during the CG-SDT occasion to transmit a CG-SDT transmission; or
wake up, based on an unsuccessful validation of the TA, the MR to start a random access small data transmission (RA-SDT) procedure.

2. The apparatus of claim 1, wherein the at least one processor is further configured to cause the UE to:
receive the TA while in a radio resource control (RRC) inactive state or an RRC release command with CG-SDT configuration via the MR; and
enter a sleep mode on the MR after reception of the TA or the CG-SDT configuration.

3. The apparatus of claim 2, wherein the at least one processor is further configured to cause the UE to:
perform a second measurement during a time window that includes the reception of the TA or the CG-SDT configuration via the MR or the WUR.

4. The apparatus of claim 3, wherein the at least one processor is further configured to cause the UE to:
compare the first measurement with the second measurement; and at least one of:
determine, based on a difference between the first measurement and the second measurement being above a threshold, that the validation of the TA is unsuccessful, or
determine, based on the difference between the first measurement and the second measurement being below the threshold, that the validation of the TA is successful.

5. The apparatus of claim 3, wherein to perform the second measurement, the at least one processor is configured to cause the UE to perform the second measurement via the MR, and wherein the at least one processor is further configured to cause the UE to:
map the second measurement to the WUR.

6. The apparatus of claim 3, wherein to perform the second measurement, the at least one processor is configured to cause the UE to perform the second measurement via the WUR.

7. The apparatus of claim 3, wherein the first measurement and the second measurement are based on one of a reference signal received power (RSRP), a received signal strength indicator (RSSI), a signal to interference and noise ratio (SINR), or a reference signal received quality (RSRQ).

8. The apparatus of claim 3, wherein the at least one processor is further configured to cause the UE to:
refrain from performing, based on the unsuccessful validation of the TA by the WUR and based on the first measurement being within the time window, a second validation of the TA via the MR.

9. The apparatus of claim 3, wherein the at least one processor is further configured to cause the UE to:
perform, based on the unsuccessful validation of the TA by the WUR and based on the first measurement being outside of the time window, a second validation of the TA via the MR.

10. The apparatus of claim 2, wherein to perform the first measurement, the at least one processor is configured to cause the UE to perform the first measurement while the MR is in the sleep mode.

11. The apparatus of claim 2, wherein the CG-SDT configuration is included in the RRC release command.

12. The apparatus of claim 1, wherein the at least one processor is further configured to cause the UE to:
output an indication of the wake up of the MR during the CG-SDT occasion or the wake up of the MR to start the RA-SDT procedure.

13. The apparatus of claim 12, further comprising one or more transceivers or one or more antennas coupled to the at least one processor, wherein to output the indication the at least one processor is configured to cause the UE to:
transmit, via the one or more transceivers or the one or more antennas, the indication of the wake up of the MR during the CG-SDT occasion or the wake up of the MR to start the RA-SDT procedure; or
store the indication of the wake up of the MR during the CG-SDT occasion or the wake up of the MR to start the RA-SDT procedure.

14. A method performed by a user equipment (UE), comprising:
receiving a low-power synchronization signal (LP SS) via a wake-up radio (WUR); and
performing a first measurement to validate a timing advance (TA) associated with a configured grant small data transmission (CG-SDT) occasion based on the LP SS via the WUR; and at least one of:
waking up, based on a successful validation of the TA, a main radio (MR) during the CG-SDT occasion to transmit a CG-SDT transmission; or
waking up, based on an unsuccessful validation of the TA, the MR to start a random access small data transmission (RA-SDT) procedure.

15. The method of claim 14, further comprising:
receiving the TA while in a radio resource control (RRC) inactive state or an RRC release command with CG-SDT configuration via the MR; and
entering a sleep mode on the MR after a reception of the TA or the CG-SDT configuration.

16. The method of claim 15, further comprising:
performing a second measurement during a time window that includes the reception of the TA or the CG-SDT configuration via the MR or the WUR.

17. The method of claim 16, further comprising:
comparing the first measurement with the second measurement; and at least one of:
determining, based on a difference between the first measurement and the second measurement being above a threshold, that the validation of the TA is unsuccessful, or
determining, based on the difference between the first measurement and the second measurement being below the threshold, that the validation of the TA is successful.

18. The method of claim 16, wherein performing the second measurement comprises performing the second measurement via the MR, and further comprising:
mapping the second measurement to the WUR.

19. The method of claim 16, further comprising:
refraining from performing, based on the unsuccessful validation of the TA by the WUR and based on the first measurement being within the time window, a second validation of the TA via the MR.

20. A computer-readable medium storing computer executable code at a user equipment (UE), the code when executed by at least one processor causes the at least one processor to:
receive a low-power synchronization signal (LP SS) via a wake-up radio (WUR); and
perform a first measurement to validate a timing advance (TA) associated with a configured grant small data transmission (CG-SDT) occasion based on the LP SS via the WUR; and at least one of:
wake up, based on a successful validation of the TA, a main radio (MR) during the CG-SDT occasion to transmit a CG-SDT transmission; or
wake up, based on an unsuccessful validation of the TA, the MR to start a random access small data transmission (RA-SDT) procedure.
